(19) United States
(12) Patent Application Publication
(10) Pub. No.: US 2025/0376065 A1
(43) Pub. Date: Dec. 11, 2025

(54) Determining a Retrieval Sequence of Operating Reserves From a Plurality of Installations for Providing a Total Operating Reserve

(71) Applicant: Siemens Aktiengesellschaft, München (DE)

(72) Inventors: Sebastian Schreck, Nürnberg (DE); Sebastian Thiem, Neustadt an der Aisch (DE); Arvid Amthor, Grabfeld OT Nordheim (DE); Michael Metzger, Markt Schwaben (DE); Stefan Niessen, Erlangen (DE)

(73) Assignee: Siemens Aktiengesellschaft, München (DE)

(21) Appl. No.: 18/877,047

(22) PCT Filed: Jun. 13, 2023
(86) PCT No.: PCT/EP2023/065708

§ 371 Date: Dec. 19, 2024

(30) Foreign Application Priority Data
Jun. 20, 2022 (EP) 22179914.1

(51) Int. Cl. B60L 53/63; B60L 53/62

(52) U.S. Cl. CPC B60L 53/63; B60L 53/62

(57) ABSTRACT

Various embodiments of the teachings herein include a method for determining a retrieval sequence of operating reserves from a plurality of electrical installations. An example includes: transmitting registration data to an aggregator unit from each installation; transmitting a value representing a current operating power to the aggregator unit from each of the installations; determining the retrieval sequence under a secondary condition that a sum of the respective available operating reserves is equal to a requested total operating reserve; and executing the retrieval from the installations according to the retrieval sequence. The respective registration data identify an availability of the respective installation for providing an available operating reserve and a respective minimum power.

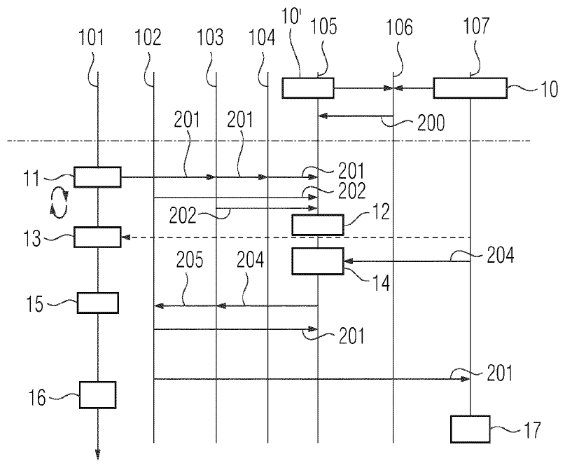

### CROSS-REFERENCE TO RELATED APPLICATIONS

This application is a U.S. National Stage Application of International Application No. PCT/EP2023/065708 filed Jun. 13, 2023, which designates the United States of America, and claims priority to EP application Ser. No. 22/179,914.1 filed Jun. 20, 2022, the contents of which are hereby incorporated by reference in their entirety.

### TECHNICAL FIELD

The present disclosure relates to power grids. Various embodiments of the teachings herein include methods and/or devices method for determining a retrieval sequence of operating reserves from a plurality of electrical installations which are connected to a power grid.

### BACKGROUND

To maintain the system stability (grid frequency) within power grids, the continuous equilibrium of consumed and provided power has to be ensured. To be able to react to variations of the generation and the consumption in real time, operating reserve capacities are provided, which can be retrieved at different speeds, for example, primary, secondary, and tertiary regulation as well as minute operating reserve. Up to this point, the operating reserve has predominantly been provided by large power plants, which can accordingly change their power dynamically in accordance with the specifications.

Due to an increasing proportion of volatile feed of renewable energy, which is difficult to predict, for example, by photovoltaic installations and wind turbines, and the disappearance of conventionally operated large power plants, for example atomic power plants, coal power plants, and/or gas power plants, the demand for operating reserve has increased, which has to be provided by decentralized energy generators and/or consumers, in particular decentralized generators, for example heat pumps, electric vehicles, and also energy storage devices, to ensure the grid stability.

If operating reserves are commercially acquired, transmission system operators tender the required positive and negative operating reserves (primary, secondary, tertiary). In this case, the minimum offer amount is one megawatt in Germany. It is therefore not possible for decentralized generators/consumers to participate in known operating reserve markets, since they typically have a power which is too small. Participation is therefore only possible by aggregation by way of an aggregator.

Furthermore, strict prequalification methods are prescribed for participating in the operating reserve market, in particular with regard to retrieval time, reaction time, ramps, and setpoint value jump. At the time of the request for the operating reserve by the grid operator, the aggregator has to ensure that the promised power is retrievable while meeting the technical requirements. The secured retrieval of flexibility (operating reserve) by a plurality of small installations (power less than 1 MW) therefore requires more complex coordination in comparison to the retrieval of operating reserve from a few large power plants.

### SUMMARY

The teachings of the present disclosure include methods and devices for providing and coordinating operating reserve by multiple small installations. For example, some embodiments of the teachings herein include a method for determining (12) a retrieval sequence of operating reserves

$${P}_{k , t}^{\pm }$$

from a plurality of electrical installations k (102), which are connected to a power grid, by means of an aggregator unit (105), wherein, for a defined time range, the aggregator unit (105) has received a surcharge (200) for providing a requested total operating reserve

$${P}_{t}^{\pm }$$

for the power grid, including: transmitting (11, 201) registration data to the aggregator unit (105) from each of the installations k (102), wherein the respective registration data at least identify an availability A_{k,t} of the respective installation k (102) for providing an available operating reserve

$${P}_{k , t}^{\pm }$$

and a respective minimum power

$${P}_{min ; k , t}^{\pm } ;$$

transmitting (11, 202) a current power

$${P}_{mea ; k , t}^{\pm }$$

to the aggregator unit (105) from each of the installations k (102); and determining (12) the retrieval sequence of the installations k (102) by way of the aggregator unit (105) under the secondary condition that the sum of the respective available operating reserves

$${P}_{k , t}^{\pm }$$

is equal to the requested total operating reserve

$${P}_{t}^{\pm } ,$$

wherein each of the available operating reserves

$${P}_{k , t}^{\pm }$$

is defined by a difference of the respective current power

$${P}_{mea ; k , t}^{\pm }$$

and the respective minimum power

$${P}_{min ; {k}_{Reject} f}^{\pm } .$$

In some embodiments,

$${P}_{k , t}^{\pm } = {P}_{mea ; k , t}^{\pm } - {P}_{min ; k , t}^{\pm } .$$

In some embodiments, the secondary condition is defined by

$${P}_{t}^{\pm } = {\sum }_{k} {P}_{k , t}^{\pm } {A}_{k , t} {μ}_{k , t} ,$$

wherein μ_{k,t} are binary variables to be determined, which each define whether the installation k (102) is intended at the time t for the provision of its available operating reserve

$${P}_{k , t}^{\pm } .$$

In some embodiments, the installations k (102) are designed as charging stations for electric vehicles.

In some embodiments, the registration data comprise a current state of charge SOC_{k,t} of an electric vehicle at the respective charging station k.

In some embodiments, the retrieval sequence is determined by means of an optimization method, wherein the target function Z=Σ_{k,t}(1−SOC_{k,t})A_{k,t}μ_{k,t} is minimized in the optimization method.

In some embodiments, the target function is expanded by a security summand.

In some embodiments, the respective available operating reserve

$${P}_{k , t}^{\pm }$$

is retrieved (14, 204, 205) according to the determined retrieval sequence by a grid regulation unit (107) of the power grid for regulation.

In some embodiments, the grid regulation unit (107) transmits a corresponding retrieval signal (204) to the respective installations k (102) and/or to respective control units (103), which convert the retrieval signal (204) into setpoint values (205) for the respective installation k (102).

In some embodiments, the surcharge (200) of the total power reserve is produced by a power reserve market (106).

In some embodiments, the determination (12) of the retrieval sequence is repeated according to defined time ranges.

As another example, some embodiments include an aggregator unit (105) for determining (12) a retrieval sequence of operating reserves

$${P}_{k , t}^{\pm }$$

from a plurality of electrical installations k (102), which are connected to a power grid, wherein, for a defined time range, the aggregator unit (105) has received a surcharge (200) for providing a requested total operating reserve

$${P}_{t}^{\pm }$$

for the power grid, characterized in that the aggregator unit (105) is designed to: receive and/or request (11, 201) registration data from each of the installations k (102), wherein the respective registration data identify at least an availability A_{k,t} of the respective installation k (102) to provide an available operating reserve

$${P}_{k , t}^{\pm }$$

and a respective minimum power

$${P}_{min ; k , t}^{\pm } ;$$

receive and/or request a current power

$${P}_{mea ; k , t}^{\pm }$$

from each of the installations k (102); and determine (12) the retrieval sequence of the installations k under the secondary condition that the sum of the respective available operating reserves

$${P}_{k , t}^{\pm }$$

is equal to the requested total operating reserve

$${P}_{t}^{\pm } ,$$

wherein each of the available operating reserves

$${P}_{k , t}^{\pm }$$

is defined by a difference of a respective current power

$${P}_{mea ; k , t}^{\pm }$$

and the respective minimum power

$${P}_{min ; k , t}^{\pm } .$$

### BRIEF DESCRIPTION OF THE DRAWING

Further advantages, features, and details of the teachings herein are apparent from the exemplary embodiments described below and with reference to the drawing. The single FIGURE in this case shows a schematic sequence of an example method incorporating teachings of the present disclosure. Identical, equivalent or functionally identical elements may be provided with the same reference signs in the FIGURE.

### DETAILED DESCRIPTION

An example method for determining a retrieval sequence of operating reserves

$${P}_{k , t}^{\pm }$$

from a plurality of electrical installations k, which are connected to a power grid, by means of an aggregator unit, wherein, for a defined time range, the aggregator unit has received a surcharge for providing a required overall operating reserve

$${P}_{t}^{\pm }$$

for the power grid, includes:
transmitting registration data to the aggregator unit from each of the installations k, wherein the respective registration data characterize at least an availability A_{k,t} of the respective installation k for providing an available operating reserve

$${P}_{k , t}^{\pm }$$

and a respective minimum power

$${P}_{min ; k , t}^{\pm } ;$$

transmitting a current power

$${P}_{mea ; t}^{\pm }$$

to the aggregator unit from each of the installations k; and
determining the retrieval sequence of the installations k by way of the aggregator unit under the secondary condition that the sum of the respective available operating reserves

$${P}_{k , t}^{\pm }$$

is equal to the requested total operating reserve

$${P}_{t}^{\pm } ,$$

wherein each of the available operating reserves

$${P}_{k , t}^{\pm }$$

is defined by a difference between the respective current power

$${P}_{mea ; k , t}^{\pm }$$

and the respective minimum power

$${P}_{min ; k , t}^{\pm } .$$

In principle, the powers can be an active power and/or an idle power. The active power of each installation is preferably less than or equal to one megawatt (small installation).

In some embodiments, the method is carried out by the aggregator unit, which comprises a computing device for carrying out one or more of the methods described herein. The aggregator unit can comprise a computing unit for determining the retrieval sequence. Furthermore, the aggregator unit aggregates the individual operating reserves of the installations to form a common operating reserve offer, which can be traded on operating reserve markets. In this case, the aggregator unit receives a surcharge for a requested total operating reserve, which is based on preceding offers of the aggregator unit on the operating reserve market.

The retrieval sequence described herein defines when and which installation contributes to providing operating reserves and therefore to the required provision of the total operating reserve.

In some embodiments, each of the participating installations transmits respective registration data to the aggregator unit. In this case, the registration data comprise at least one item of information about an availability A_{k,t} of the respective installation k for providing an available operating reserve

$${P}_{k , t}^{\pm }$$

and a respective minimum power

$${P}_{min ; k , t}^{\pm } .$$

It is thus symbolically known to the aggregator unit which installation is fundamentally available at which times and which power (minimum power) is at least required at minimum for the operation of the installation. In this case, the respective powers and variables are fundamentally time-dependent and can be provided, for example, as a time series within the defined time range. The registration data therefore comprise status information of the respective installation. In this case, the availability can comprise a fundamental availability Aₖ having values of zero and one as well as a planned availability A_{k,t}, also having values of zero and one.

In some embodiments, a current power

$${P}_{mea ; k , t}^{\pm }$$

is transmitted to the aggregator unit by each of the installations k. In other words, the aggregator unit thus knows which current power the respective installation generates or consumes, i.e. feeds into the power grid or consumes therefrom. This is necessary because the difference between current power and minimum power can fundamentally be used as the available operating reserve. The current power is acquired as a measured value or in the form of measurement data.

In some embodiments, the retrieval sequence of the installations is determined. The retrieval sequence is determined in this case under the secondary condition that the sum of the available operating reserves of the individual installations results in the requested total operating reserve. It is thus ensured that the operating reserve (total operating reserve) promised on the operating reserve market by the aggregator unit or the aggregator is delivered, i.e. provided for the power grid or the power grid operator. Moreover, it is ensured by the secondary condition that excessive operating reserve is not provided, but rather only as much flexibility of the installations is used as is required to cover the promised operating reserve demand. For this purpose, the available operating reserve of each installation is formed by the difference of the respective current power and the respective minimum power necessary for the operation of the installation. In other words, flexibilities of the individual installations are used to provide the available operating reserve. The retrieval sequence is therefore determined under technically advantageous secondary conditions, namely that the requested total operating reserve is provided by the installation in aggregation, and that the current flexibility of each installation is used for this purpose. For this purpose, the retrieval sequence can be determined by a mathematical optimization method based on a defined target function. The mentioned secondary conditions are then used as boundary conditions or secondary conditions of the optimization. The optimization is typically carried out numerically, i.e. in a computer-aided manner.

Decentralized generators/consumers can be incorporated better into an operating reserve market by the present method. Furthermore, the installations, in particular small installations having a power less than or equal to one megawatt, can be used to provide operating reserve. Therefore, in particular electric vehicles, charging stations, heat pumps, and/or photovoltaic installations can be used to provide operating reserve via the aggregator unit. For each type of installation, a specific target function or a specific term can be used within an overall target function in the above-mentioned optimization.

Furthermore, a grid operator of the power grid can establish by way of the collected data at which nodes in the grid additional flexibility could still be constructed or should be constructed. Therefore, previously unused operating reserve capacities within the power grid (distribution grid) can be opened up by the present invention. A compensation for operating reserve capacities from large power plants which have disappeared thus takes place.

Some examples include an aggregator unit for determining a retrieval sequence of operating reserves

$${P}_{k , t}^{\pm }$$

from a plurality of electrical installations k connected to a power grid, wherein, for a defined time range, the aggregator unit has received a surcharge for providing a requested total operating reserve

$${P}_{t}^{\pm }$$

for the power grid, wherein the aggregator unit is operable to:
receive and/or request registration data from each of the installations k, wherein the respective registration data characterize at least an availability A_{k,t} of the respective installation k (102) to provide an available operating reserve

$${P}_{k , t}^{\pm }$$

and a respective minimum power

$${P}_{min ; k , t}^{\pm } ;$$

receive and/or request a current power

$${P}_{mea ; k , t}^{\pm }$$

from each of the installations k; and
determine the retrieval sequence of the installations k under the secondary condition that the sum of the respective available operating reserves

$${P}_{k , t}^{\pm }$$

is equal to the requested total operating reserve

$${P}_{t}^{\pm } ,$$

wherein each of the available operating reserves

$${P}_{k , t}^{\pm }$$

is defined by a difference of the perspective current power

$${P}_{mea ; k , t}^{\pm }$$

and the respective minimum power

$${P}_{min ; k , t}^{\pm } .$$

In some embodiments,

$${P}_{k , t}^{\pm } = {P}_{mea ; k , t}^{\pm } - {P}_{min ; k , t}^{\pm } .$$

In other words, the available operating reserve of one of the installations k is determined by the difference between the current power (measured value) and the minimum required powers for its operation. It is thus advantageously ensured that the installation can continue to be operated and nonetheless operating reserve (available operating reserve) can be provided. The current power

$${P}_{mea ; k , t}^{\pm }$$

is preferably acquired by a measuring unit as a measured value.

In some embodiments, the secondary condition is defined by

$${P}_{t}^{\pm } = {\sum }_{k} {P}_{k , t}^{\pm } {A}_{k , t} {μ}_{k , t} ,$$

wherein μ_{k,t} are binary variables to be determined, which each define whether the installation k is intended at the time t for providing its available operating reserve

$${P}_{k , t}^{\pm }$$

The binary variables μ_{k,t} are determined during the determination of the retrieval sequence. They substantially establish the retrieval sequence. In other words, μ_{k,t} is in each case a binary decision variable defining the selection of the installation k (operating means) to prevent load shedding. The transmitted fundamental availability and/or the transmitted current availability of the respective installations are taken into consideration via the factor A_{k,t}. It is therefore ensured by the secondary condition that the sum of the individual available operating reserves results in the committed or promised or requested total operating reserve.

In some embodiments, the installations k are designed as charging stations for electric vehicles, in particular electric automobiles. The methods described herein may be particularly suitable for incorporating charging stations for electric vehicles into an operating reserve market.

In some embodiments, the registration data comprise a current state of charge SOC_{k,t} of an electric vehicle at the respective charging station k. The state of charge of the respective vehicle can thus be taken into consideration when determining the retrieval sequence. In particular, it is thus possible to prevent electric vehicles having a low state of charge from not being charged or only being slightly charged or the state of charge of the battery no longer being sufficient for the planned journey.

In some embodiments, the retrieval sequence is determined by means of an optimization method, wherein the target function Z=Σ_{k,t}(1−SOC_{k,t})A_{k,t}μ_{k,t} is minimized in the optimization method. An optimization method is a mathematical optimization in which a target function is minimized or maximized. The values of the variables are determined in these terms, i.e. in the best possible manner with respect to the mentioned target function, by the mentioned minimizing or maximizing. In the present case, μ_{k,t} form the variables of the target function Z to be determined. These design or form the retrieval sequence, since it is defined by them when which installation is used to provide operating reserve. The target function models the technically advantageous state for this purpose that charging stations which have a longer availability or the electrical vehicle of which has a higher state of charge are prioritized for providing the operating reserve, i.e. are farther to the front in the retrieval sequence thus determined. In other words, it is ensured by the mentioned target function that accordingly the charging stations are determined (symbolically drawn), in which the state of charge of the electrical vehicles connected thereto for charging has the least deviation from the full state of charge (SOC_{k,t}=1)).

In some embodiments, a table (lookup table) can be used for the determination by means of the optimization method. For example, vehicles having a low state of charge are assigned a low decision value EW1. Analogously, vehicles which only have a small maximum power that can be throttled receive a low decision value EW2. The charging stations are now determined which have very high decision values, wherein the decision value is calculated by, for example, EW1×EW2.

In some embodiments, the target function is expanded by a security summand. In other words, the target function may comprise such a security summand. It is may thus be ensured that if an installation should no longer be available in the time between the last calculation of the retrieval sequence and the transmission of the retrieval signal of the grid operator, for example if a charging operation was ended, a further installation is also included in the operating reserve retrieval.

In some embodiments, the respective available operating reserve

$${P}_{k , t}^{\pm }$$

is retrieved according to the determined retrieval sequence by a grid regulation unit of the power grid for the regulation. In other words, the entire available operating reserve of the installations may be retrieved according to the determined retrieval sequence by the grid operator or a grid regulation unit of the power grid for grid regulation. The installations thus provide their available operating reserve by feeding or consuming at the time determined according to the retrieval sequence.

For this purpose, the grid regulation unit can transmit a corresponding retrieval signal to the respective installations k and/or to respective control units, which convert the retrieval signal into setpoint values for the respective installation k. It may thus be ensured that the fundamental regulation of the power grid is still carried out by the grid regulation unit. The retrieval signal of the grid regulation unit can be converted for this purpose by respective control units (edge devices) into setpoint values or setpoint signals for the respective installations.

In some embodiments, the surcharge of the total operating reserve is produced by an operating reserve market. In other words, the aggregator unit is advantageously incorporated in an operating reserve market.

In some embodiments, the determination of the retrieval sequence is repeated according to defined time ranges. In other words, the method repeats itself according to defined time ranges, so that a retrieval sequence is determined again, for example, for each day, for each hour, or for each 15 minutes.

The FIGURE shows an example method incorporating teachings of the present disclosure. A chronological sequence of the method is sketched for this purpose in the direction of the ordinate. The respective incorporated units/installations/devices are plotted on the abscissa.

A respective event and/or trigger is identified by the reference sign 101.

The FIGURE shows installations 102, which are connected to a common power grid. The installations 102 can feed energy into and/or consume energy from the power grid. In particular, the installations 102 are designed as charging stations for electric vehicles.

Furthermore, the FIGURE shows control units 103 (edge devices) of the respective installations 102. The control units 103 are designed to control their associated installation 102. A respective agent unit 104 can configure the connection of the respective installation 102 to an aggregator unit 105. The respective agent unit 104 transmits registration data for this purpose, for example status information of the installations, to the aggregator unit 105.

Furthermore, the FIGURE shows an operating reserve market 105 and a grid regulation unit 107 of a grid operator of the power grid.

The overall method shown is divided by the dashed line into a trading phase and a real-time phase. The subject matter of the present invention is the real-time phase, i.e. the technical implementation of the contracts negotiated in the trading phase for providing operating reserve on the operating reserve market 106.

In the trading phase, the grid operator tenders a specific operating reserve amount (reference sign 10). The aggregation unit 105 submits a specific offer on the operating reserve market 106 (reference sign 10′). The operating reserve market determines a market result based thereon, which is transmitted to the aggregation unit 105. This surcharge of a total operating reserve requested by the aggregation unit 105 is identified by the reference sign 200. The operating reserve requested by the aggregation unit 105 is therefore defined by the trading phase, which takes place before the real-time phase.

In the real-time phase, the requested total operating reserve is to be provided by the aggregation unit 105. For this purpose, the aggregation unit 105 makes use of the installations 102, which ultimately in sum provide the total operating reserve for the aggregation unit 105. Which of the installations 102 provide which operating reserve at which time is defined by a retrieval sequence. The retrieval sequence is determined in this case according to the invention by the aggregation unit 105.

To determine the retrieval sequence, in a first step registration data and measurement data are transmitted from the installations 102 to the aggregation unit 105. The transmission of the registration data is identified by the reference sign 201.

The transmission of the measurement data, in particular the current power of the installations 102, takes place according to a second step and is identified by the reference sign 202.

In a third step, the aggregation unit 105 determines or calculates the retrieval sequence according to the present invention and/or one of its embodiments (reference sign 12). It is thus defined which of the installations 102 provide which power at which time for the provision of the requested total operating reserve.

The actual retrieval of the total operating reserve that can be provided according to the determined retrieval sequence is performed by a retrieval signal of the grid regulation unit 107, which transmits this signal to the aggregation unit 105. The retrieval signal is identified by the reference sign 204 and the retrieval of the operating reserve is identified by the reference sign 14.

Based on the retrieval signal 204, the aggregation unit 105 transmits a corresponding retrieval signal 204 to the respective control units 103. The control units 103 convert the respective retrieval signal 104 into setpoint values for the regulation/control of the respective installations 102. The setpoint values are transmitted to the installations 102 (reference sign 205). Based on the mentioned transmitted setpoint values, the actual power provision takes place according to the determined retrieval sequence. The power provision is identified by the reference sign 15.

During or after the power provision 15, the installations 102 transmit measurement data with respect to their power to the aggregator unit 105 and to the grid regulation unit 107. This is in turn identified by the reference sign 201. Based on the measurement data, or power data, transmitted to the grid regulation unit 107, it can carry out a validation 17. It is therefore advantageously ensured that the requested total operating reserve was provided and moreover it can be established which of the installations 102 have delivered which actual contribution.

The mentioned method, as indicated by the circular arrow, can repeat cyclically at a defined sampling rate and/or in an event-based manner, for example due to an arrival of an electric vehicle at one of the charging stations 102.

Although the teachings herein have been described and illustrated in more detail by way of the example embodiments, the disclosure is not restricted by the disclosed examples, or other variations may be derived therefrom by a person skilled in the art without departing from the scope of protection thereof.

### LIST OF REFERENCE SIGNS

10 tender of operating reserve demand
10′ offer submission
11 registration
12 determination of the retrieval sequence
13 activation of the operating reserve
14 retrieval of the operating reserve
15 power provision
16 end of the power provision
17 validation
101 event/trigger
102 installation
103 control unit
104 agent unit
105 aggregator unit
106 operating reserve market
107 grid regulation unit
200 surcharge
201 transmission of the registration data
202 transmission of measurement data
204 retrieval signal
205 transmission of setpoint values

What is claimed is:

1. A method for determining a retrieval sequence of operating reserves
$${P}_{k , t}^{\pm }$$
from a plurality of electrical installations k connected to a power grid by an aggregator unit, wherein, for a defined time range, the aggregator unit has received a surcharge for providing a requested total operating reserve
$${P}_{t}^{\pm }$$
for the power grid, the method comprising:
transmitting registration data to the aggregator unit from each of the installations k, wherein the respective registration data identify an availability A_{k,t} of the respective installation k for providing an available operating reserve
$${P}_{k , t}^{\pm }$$
and a respective minimum power
$${P}_{min ; k , t}^{\pm } ;$$
transmitting a value representing a current operating power
$${P}_{mea ; k , t}^{\pm }$$
to the aggregator unit from each of the installations k;
determining the retrieval sequence of the installations k using the aggregator unit under a secondary condition that a sum of the respective available operating reserves
$${P}_{k , t}^{\pm }$$
is equal to a requested total operating reserve
$${P}_{t}^{\pm } ,$$
wherein each of the available operating reserves
$${P}_{k , t}^{\pm }$$
is defined by a difference of the respective current operating power
$${P}_{mea ; k , t}^{\pm }$$
and the respective minimum power
$${P}_{min ; k , t}^{\pm } ;$$
and
executing the retrieval from the installations according to the retrieval sequence.

2. The method as claimed in claim 1, wherein
$${P}_{k , t}^{\pm } = {P}_{mea ; k , t}^{\pm } - {P}_{min ; k , t}^{\pm } .$$

3. The method as claimed in claim 1, wherein:
the secondary condition is defined by
$${P}_{t}^{\pm } = {\sum }_{k} {P}_{k , t}^{\pm } {A}_{k , t} {μ}_{k , t} ;$$
μ_{k,t} are binary variables to be determined, which each define whether the installation k is intended at the time t for the provision of its available operating reserve
$${P}_{k , t}^{\pm } .$$

4. The method as claimed in claim 1, wherein the installations k comprise charging stations for electric vehicles.

5. The method as claimed in claim 4, wherein the registration data comprise a current state of charge SOC_{k,t} of an electric vehicle at the respective charging station k.

6. The method as claimed in claim 5, wherein determining the retrieval sequence includes using an optimization method, wherein the target function Z=Σ_{k,t}(1−SOC_{k,t})A_{k,t}μ_{k,t} is minimized in the optimization method.

7. The method as claimed in claim 6, wherein the target function is expanded by a security summand.

8. The method as claimed in claim 1, wherein the respective available operating reserve
$${P}_{k , t}^{\pm }$$
is retrieved by a grid regulation unit of the power grid.

9. The method as claimed in claim 8, wherein the grid regulation unit transmits a corresponding retrieval signal to the respective installations k and/or to respective control units, which convert the retrieval signal into setpoint values for the respective installation k.

10. The method as claimed in claim 1, wherein the surcharge of the total power reserve is produced by a power reserve market.

11. The method as claimed in 1, further comprising repeating the determination the retrieval sequence according to defined time ranges.

12. An aggregator unit for determining a retrieval sequence of operating reserves
$${P}_{k , t}^{\pm }$$
from a plurality of electrical installations k connected to a power grid, wherein, for a defined time range, the aggregator unit has received a surcharge for providing a requested total operating reserve
$${P}_{t}^{\pm }$$
for the power grid, the aggregator unit programmed to:
receive and/or request registration data from each of the installations k, wherein the respective registration data identify availability A_{k,t} of the respective installation k to provide an available operating reserve
$${P}_{k , t}^{\pm }$$
and a respective minimum power
$${P}_{min ; k , t}^{\pm } ;$$
receive and/or request a current operating power value
$${P}_{mea ; k , t}^{\pm }$$
from each of the installations k; and
determine the retrieval sequence of the installations k under the secondary condition that the sum of the respective available operating reserves
$${P}_{k , t}^{\pm }$$
is equal to the requested total operating reserve
$${P}_{t}^{\pm } ,$$
wherein each of the available operating reserves
$${P}_{k , t}^{\pm }$$
is defined by a difference of the respective current power
$${P}_{mea ; k , t}^{\pm }$$
and the respective minimum power
$${P}_{min ; k , t}^{\pm } .$$
